(19) United States
(12) Patent Application Publication
(10) Pub. No.: US 2004/0118359 A1
(43) Pub. Date: Jun. 24, 2004

(54) Artificial environment for transporatation of live fish

(76) Inventor: Stephen C. Badell, Tigard, OR (US)

Correspondence Address: CHERNOFF, VILHAUER, MCCLUNG & STENZEL, 1600 ODS TOWER, 601 SW SECOND AVENUE, PORTLAND, OR, 97204-3157, US

(21) Appl. No.: 10/327,952

(22) Filed: Dec. 24, 2002

(51) Int. Cl. A01K 63/02

(52) U.S. Cl. 119/203

(57) ABSTRACT

Apparatus and a method for obtaining and maintaining life-sustaining water conditions in tanks carried on trucks to keep fish alive for relatively long periods during transport. A flow of air from a blower is cooled in a heat exchanger by a stream of air from a refrigeration unit used also to cool a space enclosing the tanks, and the flow of air thus chilled in the heat exchanger is released into the water in the tanks through diffusers, cooling and aerating the water. Rising air from a diffuser can also be used instead of a pump to circulate water from a tank through purifiers. The blower used to provide the flow of air to the diffusers is driven by the engine associated with the refrigeration unit, providing a highly reliable, simple, system.

### BACKGROUND OF THE INVENTION

The present invention is related to keeping live fish and shellfish in good condition for marketing and consumption after having been harvested, and is particularly related to keeping such live fish and shellfish in good condition while hauling them long distances over land.

In order to keep live fish (the word “fish” is used herein to include fin fish, crustaceans, such as crabs, and shellfish, such as clams) in good condition during long-distance trips, it is necessary to satisfy principal environmental requirements of the living organisms. These requirements include satisfactory water temperature, sufficient oxygen dissolved in the water, and sufficiently low levels of impurities such as biological waste products of the fish themselves.

In large aquariums, and even in market place live fish tanks, water is recirculated, filtered, and heated or cooled by large and costly pumps, water heaters, chillers, and filters. Water chemistry is carefully observed and controlled.

For transport of live fish to the market destinations, conditions under which fish can survive temporarily have been provided previously in many different ways, as evidenced in numerous patents. Such prior systems and methods, however, have generally been unsatisfactory to keep fish alive during transport for longer than a few hours, or have been very costly, or both.

It is well known that live fish can be kept in good condition for longer times if they are kept in water that is significantly cooler than water normal for their usual habitat, since relatively cold water induces dormancy. The metabolism of fish dormant as a result of significantly reduced temperature is greatly slowed, and oxygen requirements are consequently reduced. Cooling water too quickly from the normal temperature, however, can result in severe shock to the fish, so that moving fish from water resembling their normal habitat, as might be found in a live well in a fishing vessel, into a tank containing water already chilled, can severely harm or kill fish, greatly reducing its market value.

Previously available apparatus for creating and maintaining satisfactory water conditions for transport of live fish by truck has been prohibitively costly for widespread use, or has been unsatisfactory for reducing water temperature at a rate at which dormancy can be induced quickly and safely during transportation from a place where fish are off-loaded from a fishing vessel to a domestic market or an air freight terminal from which live fish can be transported further. As a result, it has previously been impractical to transport live fish over long distances, such as from coast-to-coast in the United States, except by air, which is very costly. As another result of this limitation of trucks previously used to carry live fish, air transport of live fish has required that live fish be transported quickly from the places where they are off-loaded from fishing vessels to locations near air freight terminals, where land-based tanks are equipped to provide the necessary control over water conditions to prepare live fish for reliably safe air transport.

What is needed, then, is a reliable environmental support system for controlling the temperature and assuring sufficient oxygenation and purification of water in tanks for live fish to enable such live fish to be transported over land for longer times and greater distances without exposing the live fish to unacceptable stress. Preferably, such a system should be capable of reducing water temperature adequately during transport to induce dormancy in the live fish, while also providing ample oxygenation of water in the tanks and purifying the water by removing biological waste products of the fish from the water in which the fish are transported.

### SUMMARY OF THE INVENTION

The present invention supplies an answer to the aforementioned needs, by providing environmental support apparatus and a method for aerating and controlling the temperature of water in a tank holding live fish to permit safe transportation. The apparatus includes a refrigeration unit that controls the ambient air temperature in an enclosed space surrounding the tank, a blower for forcing a flow of air into air outlet diffusers that release the air into the water of the tank as small bubbles that aerate and agitate the water, and a heat exchanger chilled or heated as needed, by a stream of air from the refrigeration unit, to adjust the temperature of the flow of air that passes through the heat exchanger from the blower and thereafter to the diffusers, so that the air released and diffused into the water in the tank also helps to control the temperature of the water in the tank.

In a preferred embodiment of the invention, a tank for holding live fish is enclosed within the cargo containing portion of a conventional thermally insulated refrigerated semi-trailer truck body. A conventional truck refrigeration unit controls the temperature of the ambient air surrounding the tank within the enclosed cargo-carrying space and also provides the stream of air to the heat exchanger to chill or heat the flow of air from the blower.

In one preferred embodiment of the invention, the blower is driven by the same engine that drives the refrigeration unit's compressor.

In one preferred embodiment of the invention, an air outlet diffuser aerates water in a conduit between the fish-holding tank and a water purification unit.

In one preferred embodiment of the invention, an air outlet diffuser is located within a container provided in line with an outlet conduit from the water purification unit and releases air to rise through the water to induce flow of purified water back to the fish-holding tank.

In one preferred embodiment of the invention, the water purification unit includes one or more mechanical filtration layers and a layer of granular media providing a large surface area supporting microbes that feed on ammonia-containing biological waste products from the live fish and thus remove materials that would harm the live fish, so that the water can be used to support the fish for a longer time.

The foregoing and other objectives, features, and advantages of the invention will be more readily understood upon consideration of the following detailed description of the invention, taken in conjunction with the accompanying drawings.

### BRIEF DESCRIPTION OF THE DRAWINGS

FIG. 1 is a sectional side view of a body of a refrigerated truck in which apparatus incorporating the present invention is installed.

FIG. 2 is a front elevational view of the truck body shown in FIG. 1, taken in the direction indicated by line 2-2 in FIG. 1.

FIG. 3 is a sectional view of the truck body and installed apparatus shown in FIG. 1, taken along line 3-3 of FIG. 1.

FIG. 4 is a top plan view of the truck body shown in FIG. 1.

FIG. 5 is a partially cut-away view of a porous air outlet diffuser for use as part of the apparatus.

FIG. 6 is a simplified view of a water purification unit in use to purify water of a fish-holding tank, in accordance with one aspect of the present invention.

FIG. 7 is a simplified view of a foam separation unit usable with the water purification unit shown in FIG. 5.

FIG. 8 is a perspective view showing the structure of a layer of the mechanical filter media used in the water purification unit of the apparatus.

FIG. 9 is a view of a pair of fish totes that can be used with the cooling and aerating apparatus.

FIG. 10 is a top plan view of the truck shown in FIG. 1, showing one manner of arrangement of fish-holding totes for transport.

### DETAILED DESCRIPTION OF THE PREFERRED EMBODIMENTS

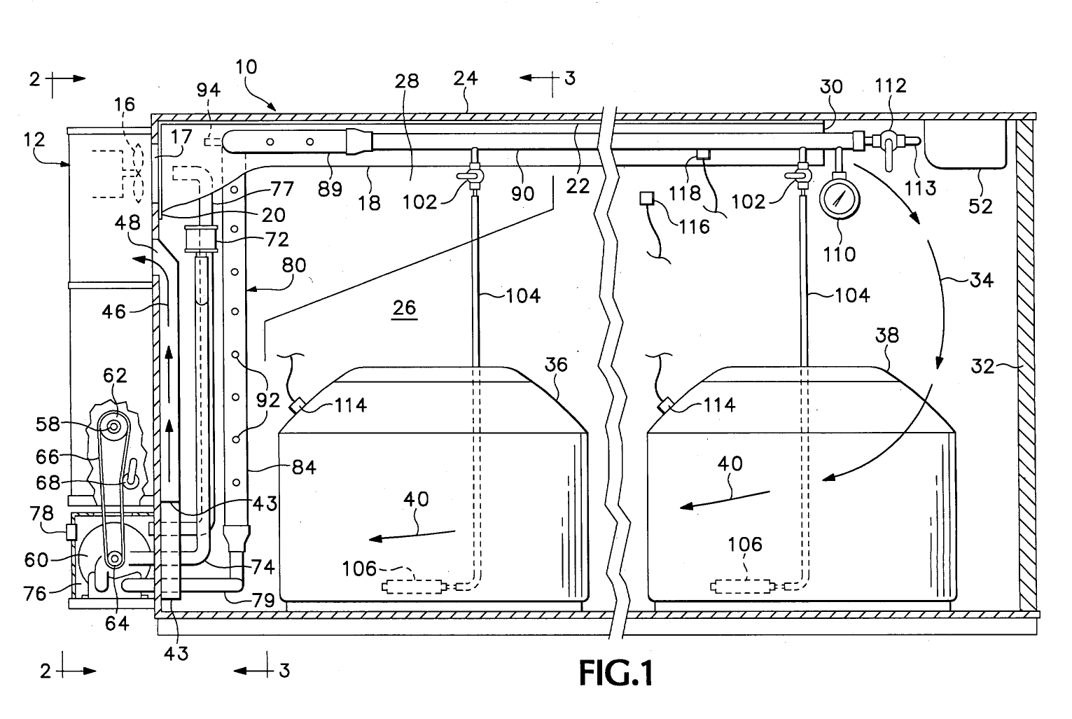

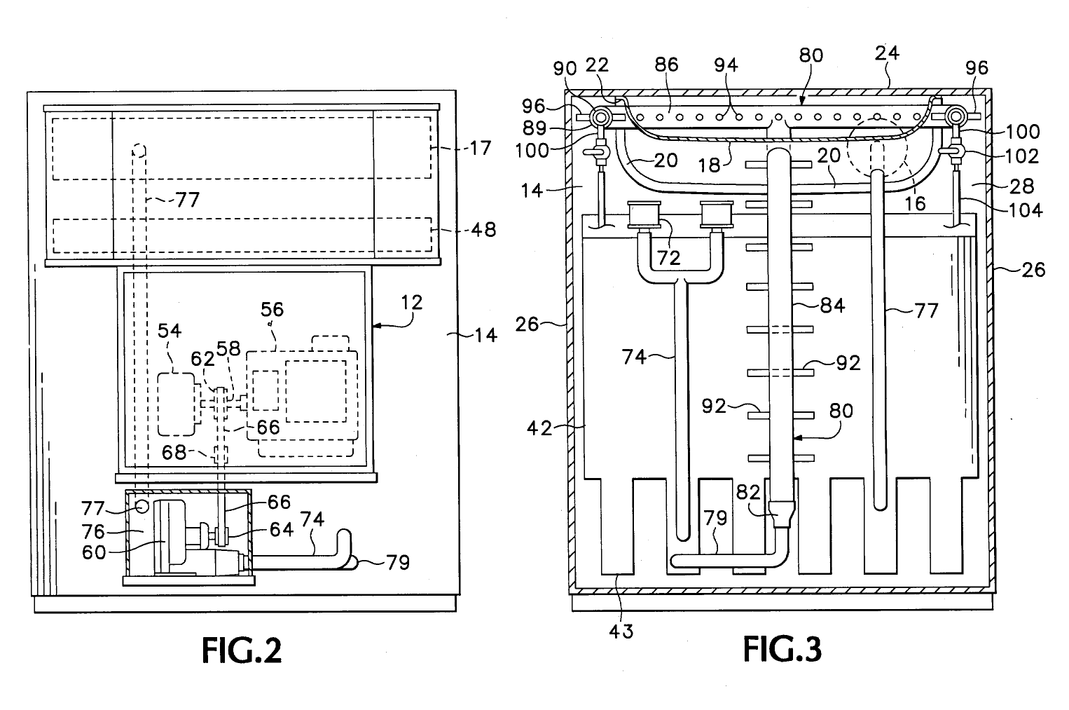

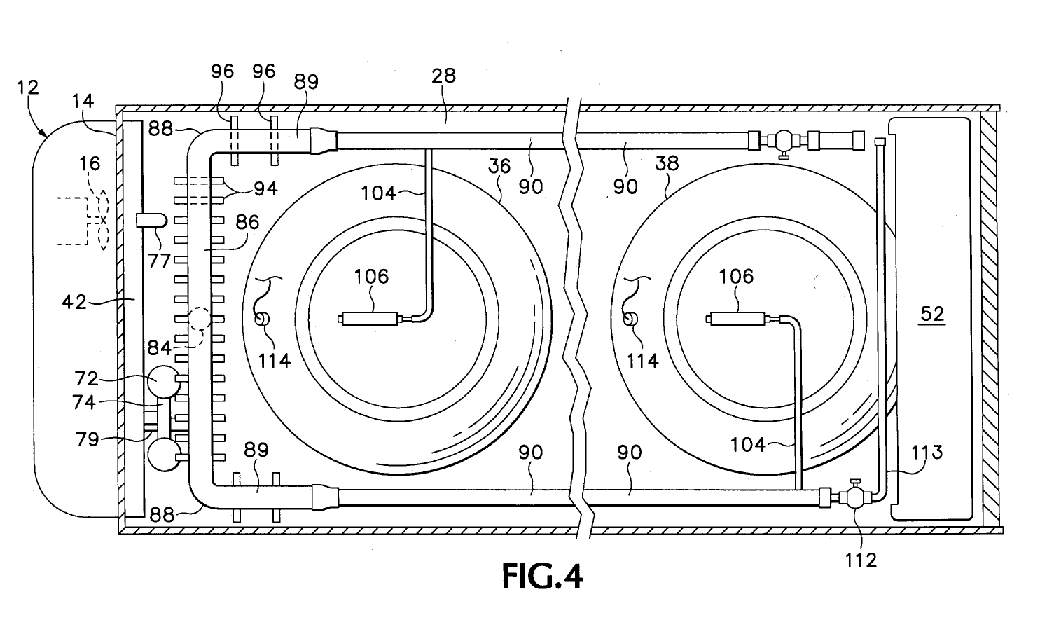

Referring now to the drawings which form a part of the disclosure herein, in FIGS. 1, 2, 3, and 4, a refrigerated truck body 10 equipped for long distance transport of live fish is shown. The truck body 10 may, for example, be a conventional forty-eight foot semitrailer with a conventional refrigeration unit 12 mounted on the outside of its front wall 14. The apparatus to be described could also be incorporated in other transportable structures, such as intermodal cargo containers, suitable railroad cars, or straight body trucks.

The term “live fish” as used herein includes many types of marine or freshwater organisms, including fin fish that normally reside in cold water, tropical fin fish, crustaceans such as various species of crabs or lobsters, and shellfish such as clams and oysters, all of which have certain water temperature, oxygenation, and purity requirements for sustenance of life. Under certain conditions they may enter into states of dormancy beneficial to transport because of reduced rates of metabolism and consequently reduced usage of oxygen and production of waste products of metabolism. As a result of various differing requirements for water quality, it may be necessary to provide an environment for the live fish which is warmer than the ambient climate outside a transport vehicle, as for fish that originate in tropical waters. More often, however, it will be necessary to cool fish-holding tanks, and the water contained within the tanks in order to ensure viability of fish caught in temperate waters while they are transported over land during weather which would result in water temperature in the fish-holding tanks being higher than that which would result in dormancy of the fish, if not higher than what could be withstood by the fish under natural conditions.

The refrigeration unit 12 in the truck body 10 includes a fan 16 arranged to blow chilled air through an opening 17 in the front wall 14, into an open front end of a plenum 18 shown in somewhat simplified form in the drawings. The plenum 18 may, for example, be defined by a strong flexible sheet material such as a plastic-impregnated canvas or other suitably strong airtight material, and has a lower front margin 20 fastened to the front wall 14 and a pair of side margins 22 each attached to the roof structure 24 along locations spaced apart from the adjacent one of the side walls 26 helping to define an enclosed space 28 within the truck body 10.

The plenum 18 extends rearwardly along the underside of the roof 24 within the space 28 defined and enclosed within the truck body 10, to an open rear end 30 of the plenum 18. Air chilled by the refrigeration unit 12 is thus directed rearward through the plenum to a location spaced forward a distance of a few feet from the rear end doors 32 of the truck body 10. The chilled air discharged from the plenum is then free to circulate downward toward the floor 27 within the enclosed space 28 as indicated by the arrows 34 and to circulate over and around the surfaces of fish-holding water tanks 36 and 38.

The air flows further forward as indicated by the arrows 40, to a false wall or baffle 42 inside the enclosed space 28 extending parallel with and spaced a small distance away from the front wall 14. The air, by the time that it reaches the baffle 42, has become somewhat warmer as a result of absorbing heat from the water tanks 36 and 38 and from the side walls 26 and other surrounding materials within the enclosed space 28. The air then passes through openings 43 at a bottom margin of the baffle 42 and flows upward between the baffle and the front wall 14 as indicated by the arrows 46, passing through an opening 48 in the front wall 14 and into contact with the coils of the refrigeration unit 12 to be further cooled.

The refrigerated truck body 10 is preferably a well-constructed, well-sealed truck body, and the refrigeration unit 12 is preferably a large capacity unit of high quality, thermostatically controlled to maintain the temperature of the air it circulates within adjustable limits. For example, a refrigerated 48-foot truck/trailer unit manufactured by Great Dane Trailers, of Savannah, Ga. under the trademark SUPERSEAL, with its floor, roof, side walls and end doors and walls insulated by urethane foam insulation, is a satisfactory truck body, and a refrigeration unit manufactured by Carrier, of Syracuse, N.Y., as its GENESIS TM1000 unit, capable of a cooling capacity of up to 32,000 BTU's, is satisfactory as a refrigeration unit for such a truck body.

It will be understood that the refrigeration unit 12 may also include a heating element and is therefore capable of heating the air circulated through the plenum 18 and in the directions indicated by the arrows 34, 40, and 46. Preferably, a remotely located rear refrigeration evaporator unit 52 is provided as a part of the refrigeration unit 12. The rear evaporator unit 52 is located adjacent the roof 24, near the rear end 32 of the truck body 10, and is provided with compressed refrigeration fluid from the compressor 54 of the refrigeration unit 12.

The compressor 54 is driven by a reliable prime mover such as a diesel engine 56 whose output shaft 58 extends transversely with respect to the truck body 10. A blower 60 is also driven by the engine 56, through a belt drive assembly including a drive pulley 62 on the shaft 58, a driven pulley 64 on the shaft of the blower 60, and a belt 66 tensioned by an idler pulley 68, so that the blower 60 is operating whenever the belt 66 is placed in tension by the idler pulley 68 and the engine 56 is running. In one embodiment of the invention, the drive belt 66 may be a six-rib schedule L drive belt, and the pulleys 62 and 64 are of corresponding design.

The blower 60 is preferably a regenerative rotary blower capable of putting out a high volume flow at a low pressure of, for example, 2-5 psig, and preferably is operated to produce a flow of about 200 cubic feet per minute at a pressure of about sixty inches of water. For example, a suitable blower is the model SDR6 blower available from Gast Manufacturing, Inc. of Benton Harbor, Mich. The blower 60 is suitably mounted on the front of the refrigerated truck body below the refrigeration unit 12.

The blower 60 receives ambient air from within the enclosed space 28 through an intake head 72 which may include a pair of filters. An associated intake conduit 74 extends through the front wall 14 into a blower compartment 76 that is thermally insulated to avoid unnecessary heating of the blower 60 by outside ambient air.

To avoid overheating of the blower 60, a cooling air pipe 77 is provided inside the truck body 10 and has an open end facing toward the refrigeration unit 12 above the plenum 18 to receive and carry a small amount of air downward and into the blower compartment 76. A small electric fan 78 may also be provided in one wall of the blower compartment 76 to help exhaust air from the blower compartment 76 and thus induce flow of chilled air from the plenum 18 to the blower compartment 76 via the pipe 77.

An outlet conduit 79 leads from the blower 60 back through the front wall 14, into the interior of the enclosed space 28. Within the truck body 10, it extends horizontally toward the middle of the width of the truck body, and thence turns upward and is connected to the upstream end of a heat exchanger 80. The intake conduit 74 and outlet conduit 79 may, for example, be of three-inch diameter PVC pipe, connected with suitable elbow fittings, and the portions of those conduits extending between the front wall 14 and the blower compartment 76, outside the enclosed space 28, are preferably covered with a suitable thermal insulation material. A simple rubber reducer coupling 82, held by large hose clamps, may be used to connect the outlet conduit 79 with the inlet or upstream end of the heat exchanger 80.

The heat exchanger 80 is of a simple, durable design and construction intended not to impede the flow of air from the blower 60, and preferably is made of an efficient thermally conductive material, such as a suitable metal. In one preferred embodiment of the environmental support apparatus, the heat exchanger 80 includes a riser section 84 of four-inch diameter copper pipe extending vertically and connected at its upper end to a similar but horizontal T-arm section 86 extending transversely within the enclosed space 28, near the roof 24 and within the plenum 18, as shown in FIGS. 1 and 3. Each end of the T-arm section 86 extends outside the plenum 18 to an elbow 88 and is connected with a rearwardly-directed outlet or downstream end 89 of the heat exchanger adjacent each side wall 26 of the truck body. A suitable coupling interconnects the downstream or outlet end 89 of the heat exchanger 80 with an outlet manifold 90 extending rearwardly along each sidewall 26 adjacent the roof 24 of the truck body on each side of the truck body 10, as shown in FIGS. 1 and 3.

The heat exchanger 80 includes several small, for example, ¾ in. diameter, copper through pipes 92 that extend transversely entirely through and for a few inches on each side of the copper pipe of the riser section 84. The through pipes 92 are open at each end, but are connected sealingly, as by brazing, to the wall of the riser section 84 where they pass through, so that they separate the ambient air in the enclosed space 28 within the truck body 10 from the flow of air within the outlet conduit 78 and the heat exchanger 80. The through pipes 92 may be parallel with each other and spaced apart from each other by a distance of, for example, eleven inches in the riser section 84.

Similar through pipes 94 extend similarly through the four-inch diameter copper pipe of the T-arm section 86 of the heat exchanger and are connected with it in a similar fashion. The through pipes 94 are spaced closer together, about five inches apart, for example, and extend generally longitudinally of the truck body 10, aligned with the movement of a stream of air from the refrigeration unit 12 into the plenum 18, as shown in FIG. 1. A stream of chilled or heated air from the refrigeration unit 12 passes through the through pipes 94 as well as around the outside of the T-arm section 86 of the heat exchanger within the plenum 18.

Additional through pipes 96 are provided in the outlet end portions 88, and preferably extend horizontally and transversely as shown in FIGS. 1 and 3. The through pipes 92 and 96 assist in transfer of heat between the ambient air within the enclosed space 28 outside the plenum 18 and the air flow from the blower 60 within the heat exchanger 80.

As a result of friction, operation of the blower 60 increases its temperature. The blower 60 imparts heat to the flow of air provided by the blower 60 into its outlet conduit 78, raising the temperature of that air several degrees from that of the air in the blower intake conduit 74. During typical cooling operation of the system according to the invention, the heat exchanger 80 transfers a portion of the heat from the flow of air from the blower 60 to the ambient air around the riser section 84 and the outlet end portions 89. The heat exchanger 80 also transfers a significant amount of heat into the stream of air from the refrigeration unit 12 passing through and around the T-arm section 86 and its through pipes 94 of the heat exchanger 80, within the plenum 18. From the outlet ends 89, the flow of air from the blower 60 is delivered into the two manifolds 90 extending longitudinally within the truck body 10 at a temperature several degrees cooler than the air in the outlet conduit 78.

The outlet manifolds 90 are of suitable airtight material, for example, three-inch diameter schedule 80 PVC piping, which may be attached to the roof 24 by suitable pipe hangers. The manifolds 90 extend rearwardly within the truck body toward the rear end 32, and several outlet conduits 100, for example, as many as twenty, are located at intervals along each of the manifolds, each provided with a suitable control valve 102. For example, suitable outlet conduits 100 are ½ inch diameter metal pipes with threaded ends fitted into the wall of the manifold 90. The control valves 102 can be used to regulate the volume of flow through each, as well as reliably to close each outlet conduit 100 securely. Each control valve 102 is provided with an outlet nipple, which may be of a barbed push-on connection type to which a flexible outlet jumper hose 104 can be easily attached sealingly.

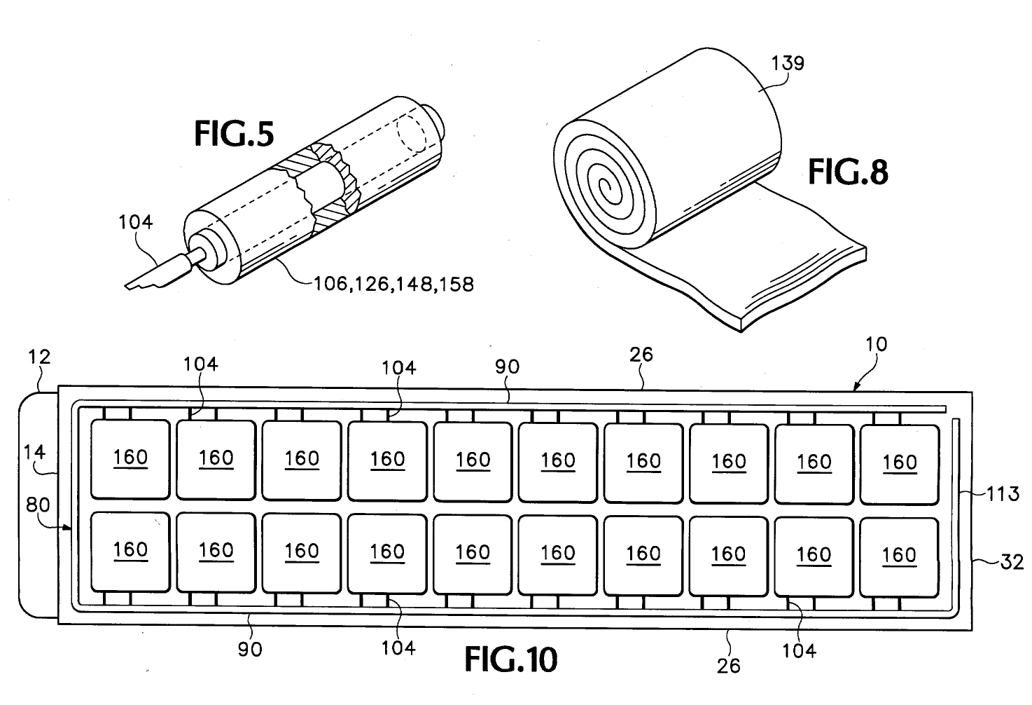

Each outlet jumper hose 104 may be connected to an air outlet diffuser 106. The diffusers 106, as shown in FIG. 5, may, for example, be of a porous tubular material often used in water filter elements. The diffusers 106 have a porous construction through which air can pass with a relatively small amount of resistance, but whose surface releases air in the form of very small bubbles as a result of the small pores and passageways defined in the material.

In the case of large tanks such as the fish-holding tanks 36 and 38 shown in FIG. 1, four or more outlet jumper hoses 104 and air outlet diffusers 106 may be utilized with each such tank, which may be over four feet in depth and may hold nominally 1,000 gallons of water and live fish. For the sake of clarity, only a single outlet jumper hose 104 and air outlet diffuser 106 is shown in each of the tanks 36 and 38 in FIG. 1. With the control valves 102 open to let air from the manifold 90 into each of the outlet jumper hoses 104, the several air outlet diffusers 106 provide a large volume of air to be released into the water within each of the tanks 36 and 38 in the form of very small bubbles which rise through the water and are dissolved into the water to provide an ample supply of oxygen for the live fish contained within the tanks 36 and 38.

At the same time, the movement of the air released from the outlet diffusers 106 keeps the water within the tanks 36 and 38 moving and, because of the temperature of the air released from the air outlet diffusers 106, the part of the flow of air from the manifold 90 passing into each of the fish-holding tanks 36 and 38 through the air outlet diffusers 106 helps to quickly adjust the temperature of the water within the tanks during normal operation of the system. Thus air from the refrigeration unit 12 lowers the ambient air temperature within the enclosed space 28 and thus cools the tanks 36 and 38 along their walls and the upper surface of the water contained in the tanks. Also, the cool air passed into the water within the tanks through the air outlet diffusers 106 helps to bring the water within the tanks 36 and 38 to the desired temperature quickly.

At the rear end of one of the manifolds 90, a pressure gauge 110 provides an indication of how to adjust a valve 112 to maintain sufficient pressure in the manifolds 90, so that air will reliably be delivered from the air outlet diffusers 106 into water within the tanks 36 and 38. The volume of air allowed to escape from the manifold 90 through the pressure-regulating valve 112 is delivered into a perforated pipe 113. The pipe 113 extends transversely along the remote rear evaporator 52, located near the rear end wall 32 of the truck body 10, which can then further cool air released from the holes (not shown) in the pipe 113. The air thus further cooled joins the air carried rearward by the plenum 18, to assist in cooling the air within the enclosed space 28 of the refrigerated truck body.

It will be understood that various sensors such as temperature sensors 114 may be utilized to sense the temperature of the water in the fish-holding tanks 36 and 38 and to provide a remote readout of those temperatures. Similarly, one or more temperature sensors 116 may be utilized to sense and provide a remote readout of the temperature of the ambient air within the enclosed space 28, and one or more sensors 118 may be utilized to sense the temperature within one or each of the air manifolds 90 and provide remote readouts to guide in operation of the system in order to provide life-sustaining conditions for the fish carried in the tanks 36 and 38.

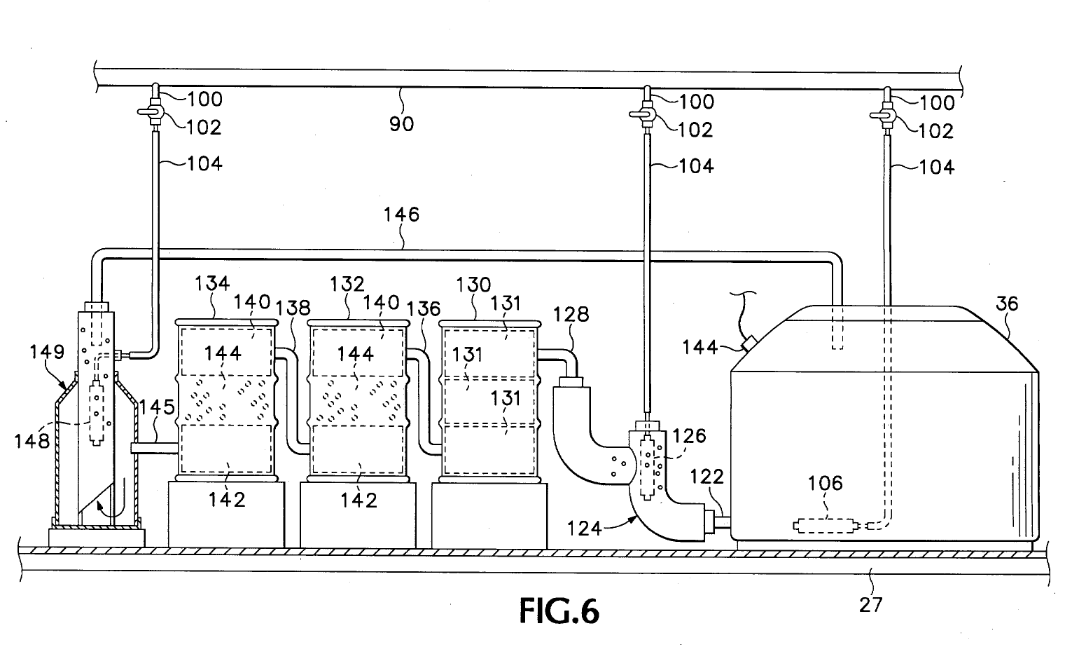

Not only are the temperature and aeration of the water in a fish-holding tank 36 important, but it is also important that the water be kept free enough from waste materials from the live fish not to adversely affect their health. Accordingly, a water purification unit is also provided in association with the tanks, as shown in FIGS. 6, 7, and 8. A water purification unit inlet conduit 122 extends from near the bottom of the fish-holding tank 36 into an aeration unit 124 provided with a flow of air from a diffuser 126 included within the aeration unit 124.

Water flowing from the fish-holding tank 36 is aerated slightly and then flows through a filter inlet conduit 128 into a first filter container 130 which is filled with three layers of somewhat compressed bonded polyester fiber batting 131 to perform mechanical filtration, followed by second and third purification containers 132 and 134, interconnected by conduits 136 and 138 leading from the bottom of each container 130,132 to the top of the successive container 132, 134. As shown in FIG. 8, the bonded polyester fiber batting 131 may be prepared in the form of long ribbon-like batts 11 inches wide, about 1.5 in. thick, and about 12 yards long, which can be rolled into a cylinder 139 that can be squeezed into a plastic 55 gallon drum.

The second and third purification containers 132, 134 each contain a top layer 140 and a bottom layer 142 of the same sort of coiled bonded polyester fiber batting, with a central layer 144 of granules. The granules may be of reclaimed high-density polyethylene plastic of irregular shape, whose largest dimension may preferably range from approximately 0.050 in. to 0.150 in., although other granule sizes would also be acceptable. The large surface area presented by those granules supports colonies of bacteria capable of subsisting on ammonia-bearing waste products of fish and thus act as a biological purification unit, cleansing salt water. Ammonia can also be absorbed by the use of other filter media such as Zeolite for maintaining the quality of fresh water.

The bonded polyester fiber batting can be removed, spread, and rinsed clean periodically, then rerolled and inserted into the container from which it originated. This is preferably performed routinely with the mechanical filtration media within the first or mechanical filtration container 130 and much less frequently with the media within the second and third purification containers 132 and 134, in order to avoid disturbing the bacteria living on the surfaces of the plastic granules within those container units.

The purified water exits from the third purification container 134 through an outlet conduit 145 and is carried by the pumping action of a flow of air from a diffuser 148 supplied by an outlet jumper conduit 104 in a pump assembly 149, to carry the purified water back into the tank 36. Rising air from the diffuser 148 carries water along in an upward direction in the larger diameter body of the pump assembly 149, inducing flow toward the tank 36 along the conduit 146.

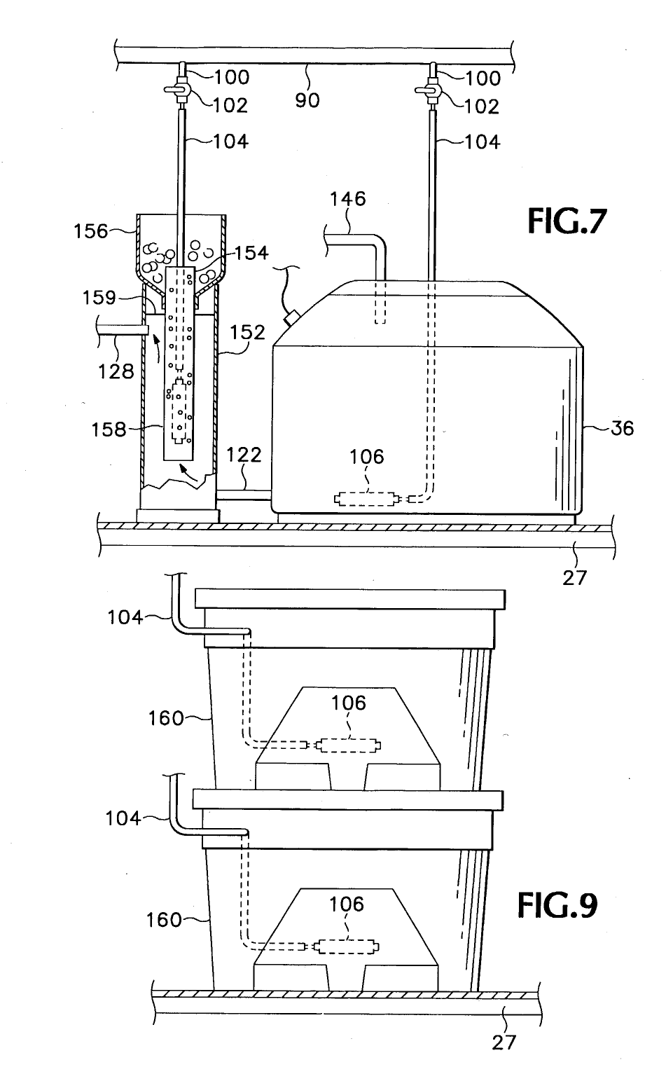

A foam fractioner 150, shown in simplified view in FIG. 7, can be utilized for salt water, between the fish-holding tank 36 and the mechanical filtration container 130. The foam fractioner 150 may be constructed as an upright open ended eight inch diameter pipe 152 with a four inch diameter pipe 154 held centrally located, as by funnel 156 and extending downward to within a few inches from the bottom of the eight inch pipe. An air outlet diffuser 158 is located within the four inch diameter pipe 154 and within a few inches of its bottom end. A stream of air exiting from the diffuser 158 as a flow of very small bubbles results in formation of foam at the top, above the water level 159 in the device. The foam carries away dissolved or suspended solids which are dispersed at the upper surface of the liquid contained within the funnel around the four-inch PVC pipe.

As shown in FIGS. 9 and 10, instead of a small number of large tanks 36, etc., each having several diffusers 106 connected through associated jumper conduits 104, the truck 10 or other enclosed structure for transporting live fish may also be loaded with standard 180 gallon totes 160. In a 48 foot semi-trailer 10 up to forty totes 160 can be carried, stacked two high along each of the side walls 26, leaving a walkway down the center line of the semi-trailer 10. A separate diffuser 106, fed by its own outlet valve 102 and jumper conduit 104, is used in each one of the totes. Each tote 160 can then be used to carry up to five hundred pounds of live crabs in about 75 gallons of water, which is adequately aerated and cooled by the parts of the flow of air from the blower 60 chilled by the stream of air from the refrigeration unit passing over and through the heat exchanger 80 as described above.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

1. A system for aerating and controlling the temperature of water in a fish tank, comprising:
(a) a blower providing a flow of air at a low pressure and a first temperature through an output conduit;
(b) a heat exchanger having an upstream end arranged to receive and conduct said flow of air from said output conduit;
(c) a refrigeration unit arranged to provide a stream of air onto said heat exchanger and thereby to change the temperature of said flow of air as it passes through said heat exchanger;
(d) an air outlet manifold interconnected with said heat exchanger so as to receive said flow of air from within said heat exchanger at a downstream end of said heat exchanger, said manifold including a plurality of outlet conduits;
(e) a jumper conduit connected with one of said outlet conduits so as to receive and conduct a portion of said flow of air from said manifold;
(f) an air outlet diffuser interconnected with said jumper conduit and located beneath a quantity of water in said fish tank so as to receive said portion of said flow of air and release said portion of said flow of air into said quantity of water, thereby aerating and helping to control the temperature of said quantity of water.

2. The system of claim 1 wherein said refrigeration unit and said blower are driven by a single prime mover.

3. The system of claim 1 wherein said refrigeration unit has an associated heating unit and is capable of providing said stream of air over said heat exchanger at a selected temperature.

4. The system of claim 1 wherein said fish tank and said heat exchanger are located within an enclosed space containing a body of air, and wherein said refrigeration unit is arranged to create and maintain a selected temperature in said body of air.

5. The system of claim 1 wherein said blower provides said flow of air to said air outlet manifold at a selected pressure.

6. The system of claim 1 further including a water purification unit including an air outlet diffuser arranged to aerate a quantity of water from said tank as said quantity of water enters said purification unit.

7. A system for controlling an aquacultural environment, comprising:
(a) a structure defining an enclosed space;
(b) a fish-holding tank located within said enclosed space and containing a quantity of water;
(c) a refrigeration unit arranged to direct a stream of air at a selected temperature into said enclosed space;
(d) a blower capable of providing a high volume flow of air at a predetermined low pressure;
(e) a heat exchanger having upstream and downstream ends, and a blower output conduit interconnecting said blower with said upstream end so as to conduct said flow of air from said blower into said heat exchanger;
(f) an air manifold located in said enclosed space and arranged to receive said flow of air from said downstream end of said heat exchanger, said manifold including a plurality of outlet conduits;
(g) a jumper conduit connected with one of said outlet conduits so as to conduct a portion of said flow of air from said manifold; and
(h) an air outlet diffuser located in said tank within said quantity of water and interconnected with said jumper conduit so as to receive said portion of said flow of air and release said portion of said flow of air into said quantity of water, thereby aerating and helping to control the temperature of said quantity of water.

8. The system of claim 7 wherein said structure is thermally insulated.

9. The system of claim 7 wherein said refrigeration unit is arranged to receive air from inside said enclosed space, adjust the temperature of said air, and then direct said air back to said enclosed space as a part of said stream.

10. The system of claim 7 wherein said blower is arranged to receive a quantity of air from inside said enclosed space and deliver said quantity of air into said upstream end of said heat exchanger at said predetermined low pressure.

11. The system of claim 7 wherein said heat exchanger is located within said enclosed space and said refrigeration unit is arranged to direct a part of said stream of air through and around said heat exchanger.

12. The system of claim 7 wherein said heat exchanger includes a large metal conduit for said flow of air from said blower and a plurality of metal cooling tubes extending through and within said large metal conduit and arranged to conduct a part of said stream of air from said refrigeration unit.

13. The system of claim 7 wherein said diffuser includes a generally tubular body having a wall of porous material and said portion of said flow of air is directed into an interior of said body and passes out through said wall.

14. The system of claim 7 wherein said refrigeration unit includes a prime mover and said blower is also driven by said same prime mover.

15. The system of claim 7 wherein said structure is a semi-trailer truck body.

16. The system of claim 7 wherein said structure is an intermodal cargo container.

17. The system of claim 7 wherein said structure is a truck body.

18. The system of claim 7, further including a water purification unit connected with said tank so as to receive a quantity of water from said tank.

19. The system of claim 18 wherein said water purification unit includes a mechanical filter and a biological purification element.

20. The system of claim 18 including a plurality of said jumper conduits and wherein one of said jumper conduits is connected to an air outlet diffuser located in a conduit extending between said tank and said purifier unit, and arranged so that said diffuser aerates said quantity of water received from said tank.

21. A method of providing an aquaculture environment for sustaining live fish during transport, comprising the steps of:
(a) establishing and maintaining a selected air temperature in an enclosed space surrounding a fish tank containing a quantity of water;
(b) taking a quantity of air from said enclosed space and creating a flow of said air at a first temperature; and
(c) releasing a portion of said flow of air into said water in said fish tank as small bubbles, thereby agitating and aerating said water, and bringing said water in said tank to a selected temperature.

22. The method of claim 21 wherein said selected temperature of said water in said fish tank is low enough to induce said live fish to become dormant.

23. The method of claim 21 including the further step of circulating a portion of said water from said tank through a purification unit and thereafter returning said water into said tank in a purified condition.

24. The method of claim 23 including the step of removing biological waste products of live fish from said portion of said water in said purification unit by action of microbes contained in a biological purification portion of said purification unit.

25. The method of claim 21 wherein said step of creating a flow of air at a selected temperature includes the step of chilling said flow of air and wherein said step of bringing said water to a selected temperature includes the step of chilling said water by releasing said portion of said flow of air into said water.
